(19) United States
(12) Patent Application Publication
(10) Pub. No.: US 2025/0054406 A1
(43) Pub. Date: Feb. 13, 2025

(54) USER PERSONALITY TRAITS CLASSIFICATION FOR ADAPTIVE VIRTUAL ENVIRONMENTS IN NON-LINEAR STORY PATHS

(71) Applicant: BRITISH TELECOMMUNICATIONS PUBLIC LIMITED COMPANY, London, Greater London (GB)

(72) Inventors: Tiago ANDRADE, London (GB); Anasol PENA-RIOS, London (GB); Max SMITH-CREASEY, London (GB); Ozkan BAHCECI, London (GB)

(21) Appl. No.: 18/716,425

(22) PCT Filed: Nov. 23, 2022
(86) PCT No.: PCT/EP2022/082964

§ 371 Date: Jun. 4, 2024

(30) Foreign Application Priority Data
Dec. 8, 2021 (GB) 2117713.4

(51) Int. Cl. G09B 7/04

(52) U.S. Cl. CPC G09B 7/04

(57) ABSTRACT

User personality traits classification for adaptive virtual environments in non-linear story paths A method of providing adaptive training to a user in a training environment is provided. The method comprises generating, by a machine learning agent, a training scenario for a user, wherein the training scenario is generated based on a personality biometric profile and one or more personality characteristics of the user. The user is trained in a training session using the training scenario wherein, during the training session, the machine learning agent modifies the training scenario in real time based on user behavioural data that reflects the user's behaviour in the training session.

### TECHNICAL FIELD

Embodiments described herein relate generally to a method of generating tailored training scenarios for users.

### BACKGROUND

The personalisation of virtual environments may be employed to in a variety of different scenarios and for a variety of different uses. For example, such personalised systems may be used in learning and training scenarios, where the environment may adapt to the learning progress of the user, thereby enhancing and encouraging learning.

However, the implementation of such systems presents some challenges. For instance, many applications limit the agent and the environment's authority on the course of the scenarios, resulting in linear progression and removing any significance associated with the user's actions. Furthermore, such learning and training sessions may not be unique, and may play out identically to previous sessions for that user. As a result, it would be beneficial to be able to deliver training that is specifically tailored and personalised for a given user, without the need for unnecessary time spent calibrating the training environment.

### SUMMARY OF INVENTION

In accordance with a first aspect of the invention, there is provided a method of providing adaptive training to a user in a training environment, the method comprising: receiving a personality biometric profile and one or more personality characteristics of a user; generating, by a machine learning agent, a training scenario for the user, wherein the training scenario is generated based on the personality biometric profile and the one or more personality characteristics of the user; training the user in a training session using the training scenario; wherein, during the training session, the machine learning agent modifies the training scenario in real time based on user behavioural data that reflects the user's behaviour in the training session.

The present invention therefore provides a method of adaptively providing training to a user in a training environment, where a machine learning agent generates a training scenario for the user using a personality biometric profile for the user and the personality characteristics for that user. The training scenario generated therefore may be tailored to the specific user in question, including from the initial training session, thereby saving time calibrating the training scenario to the user in the initial training session. User behavioural data collected in real time during the training session allows for the training scenario to be modified in real time, where the user behavioural data reflects the user's behaviour during the training session. As a result, the training session can be dynamically adapted to the user as the user works through the training scenario. The user is then able to receive ongoing training that is more efficient and personalised for their particular personality and behaviour, allowing for better overall training and encouragement towards chosen learning goals.

Any of the following may be applied to the above first aspect of the invention.

The machine learning agent may control a plurality of non-player characters in the training scenario, and modifying the training scenario may include modifying the behaviour of one or more of the plurality of non-player characters.

Modifying the training scenario may be based on user behavioural data exceeding a threshold.

The training scenario may be modified based on an assessment, by the machine learning agent, of the current personality state of the user, wherein the assessment may be based on the user behavioural data.

Generating the training scenario for the user may be based on a weighted score for each personality characteristic of the user.

The training scenario may be modified in order to achieve a training goal.

Training the user in the training session may comprise the user being trained in a virtual reality (VR) environment, and modifying the training scenario may include modifying the VR environment.

The training scenario may be modified according to a pre-set series of modification options.

The training scenario may comprise a plurality of tasks to be completed by the user in the training session, and modifying the training scenario based on the user's behaviour may include one or more of: including one or more additional tasks or removing one or more existing tasks; changing the difficulty of one or more tasks; changing the complexity of one or more tasks; providing a hint to the user related to the current task; or including or removing additional information provided to the user related to the current task.

The training scenario may comprise a plurality of tasks to be completed by the user in the training session, and the user behavioural data may include one or more of: the time taken by the user to select an option during a task; how often the user selects the correct option when completing one or more of the plurality of tasks; how quickly the user selects the correct option during one or more task; how many interactions the user has with the plurality of non-player characters in the training scenario, or how often the user makes a random selection during one or more tasks.

The user biometric profile may be updated based on the user behavioural data, and a next training scenario for the user may be generated by the machine learning agent subsequent to the training session based on the updated user biometric profile.

The personality biometric profile may be updated subsequent to the training session based on user biometric data collected from a plurality of user devices during the training session.

The one or more personality characteristics may comprise one or more of Stressed, Assertive, Leadership, Conscientiousness, Openness, and Receptive.

In accordance with a second aspect of the invention, there is provided a system comprising: one or more processors; a non-transitory memory; and one or more programs, wherein the one or more programs are stored in the non-transitory memory and configured to be executed by the one or more processors, the one or more programs including instructions for performing any of the methods of the first aspect of the invention discussed above.

In accordance with a third aspect of the invention, there is provided a non-transitory computer readable storage medium storing one or more programs, the one or more programs comprising instructions, which, when executed by an electronic device with one or more processors, cause the electronic device to perform any of the methods of the first aspect of the invention discussed above.

In the following, embodiments will be described with reference to the drawings in which:

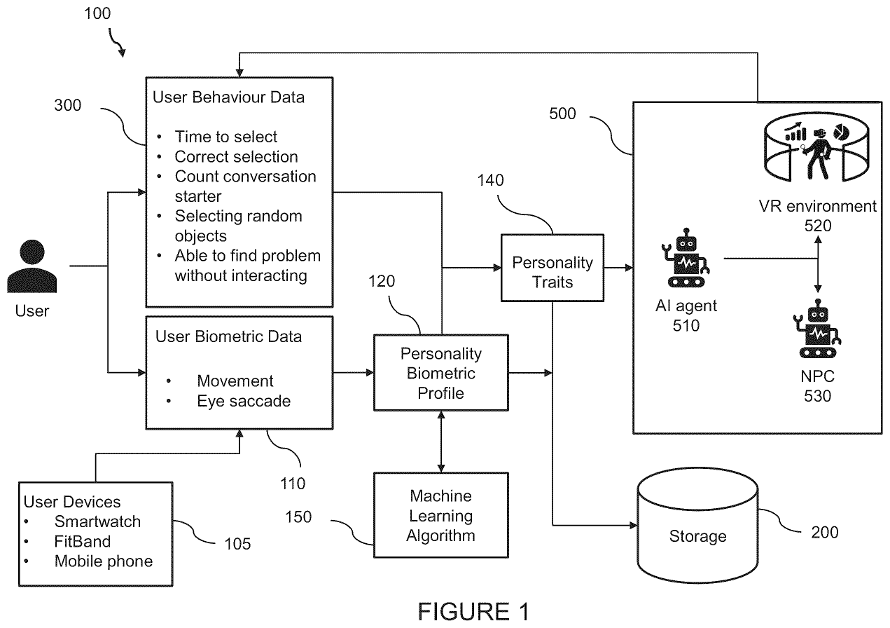

FIG. 1 shows a representation of the overall training system according to some embodiments.

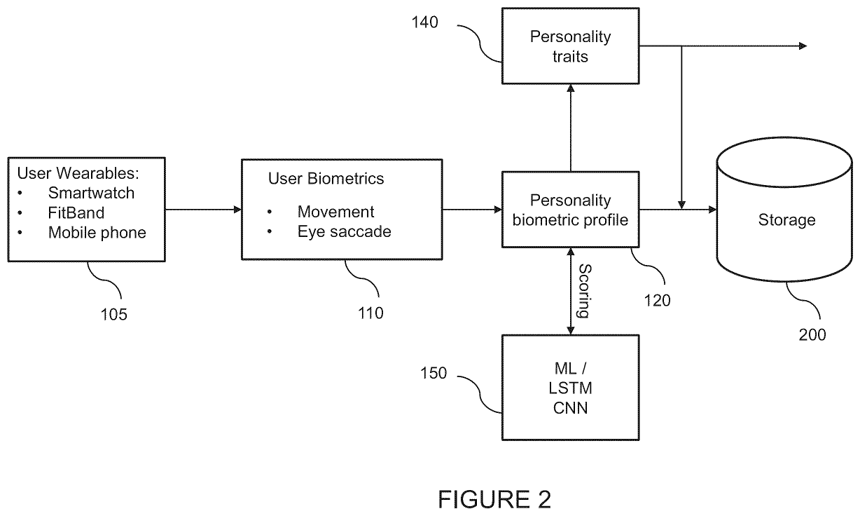

FIG. 2 shows a representation of the process for generating user biometric profiles according to some embodiments.

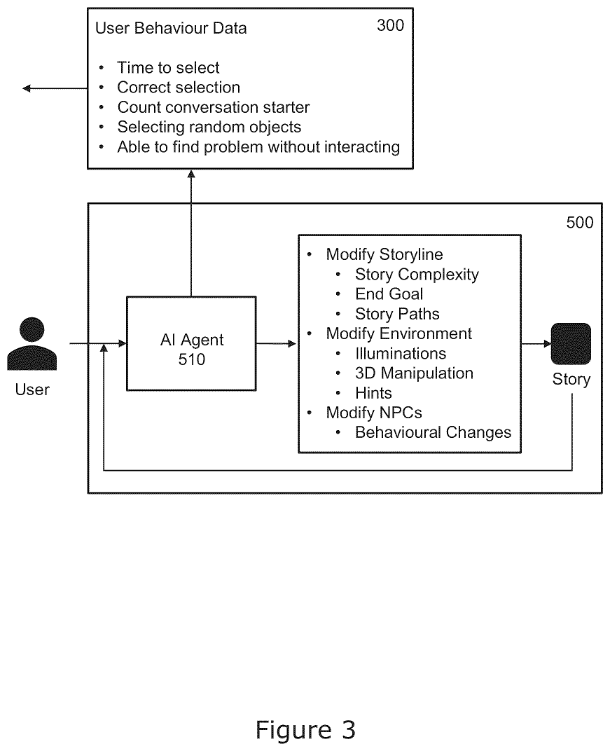

FIG. 3 shows a representation of the adjustment of the environment in response to user behaviour during a training session according to some embodiments.

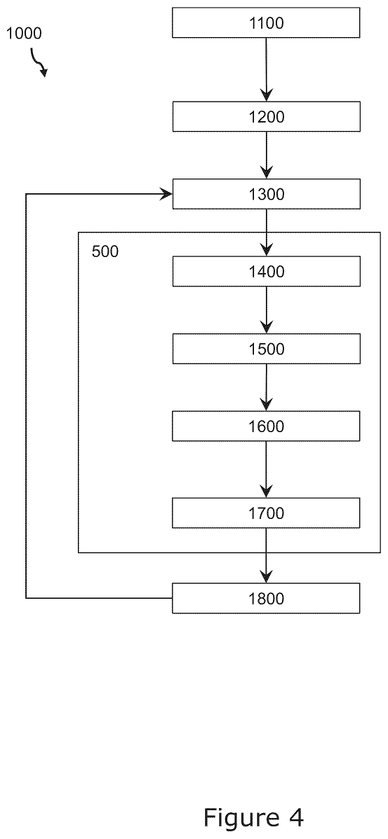

FIG. 4 shows a flowchart of the training process according to some embodiments.

### DETAILED DESCRIPTION

In the present application, a user specific personality profile is generated from information collected over time by extracting a plurality of metrics that indicates user behaviour even before the user engages directly with the training system. Here, the user specific personality profile (which may be referred to as a user personality biometric profile) correlates to a plurality of pre-existing personality traits.

The present method allows for the training system to estimate an appropriate baseline on the user personality traits and a benchmark, adapting the in-game conditions such that the first training session is already tailored for the specific user.

This differentiates from traditional methods that normally require the user to take part in several rounds with the training system with default settings to be able to extract sufficient data from the user before the training session can be suitably modified or tailored.

In addition, while the user is engaging with the training system, more metrics from the user actions may be collected, allowing for the personality biometric profile to be continuously updated. Biometric traits from the user may be collected continuously and incorporated into their biometric personality profile to facilitate the determination of their personal personality traits. As a result, unique user profile attributes can be updated and optimized in real-time.

This then allows for the training environment to use previous training session data, such as user behavioural data, to dynamically change the next training session, so that every training session is unique to that user and different from previous training sessions.

The information determined for the user's personality traits and their progression rate in the task is used as a baseline to adapt the training scenario (or storyline) towards fostering particular personality traits (i.e. to help a user achieve a particular training goal). This may be achieved by making modifications to the training environment, such as adding more tasks to the user or changing the difficulty of the tasks to adjust the complexity of the training scenario (or story).

For example, in a scenario where the user needs to make a decision within a short time, a security alarm could be automatically activated in the scene to urge the user to make a decision. If the level of complexity or stress is too high for the user, then the training environment could indicate the correct solution or action to assist the user. For instance, direct informative hints could be shown, or non-player characters (NPCs) could be made to be more collaborative, based on which personality traits need to be reinforced for performing a particular role.

A machine-learning algorithm (also referred to as a “machine learning agent”, or an “AI agent”) may be employed to make changes in the training environment to influence a user's behaviour either directly or indirectly. This may focus on changing user behaviour by reinforcing certain personality traits, instead of making the game enjoyable.

It will be understood that, while the following discussion concerns a training environment, the same system may be applied to environments that are designed primarily for user enjoyment (i.e. a game). In such a case, the training environment may be dynamically adapted to maximise the user's engagement or enjoyment of the scenario, rather than to reinforce certain behaviours or personality traits.

FIG. 1 shows an overview of the system 100 according to one embodiment of the present application. It will be understood that not all the elements shown in the figure may necessarily be implemented in all embodiments, and that the system may be implemented with fewer, or more, elements than those shown.

Here, the system 100 is designed to capture user actions and biometrics to generate, in real-time, a personality biometric profile 120 of the user. An AI agent 510 may then be used to analyse the personality biometric profile 120 and make changes to a virtual training environment 500 with the goal of promoting particular user behaviours in the virtual task(s), thereby driving the user to learn.

To encourage certain user behaviours, the training environment 500 can be modified during each training session (e.g. changing colours, showing/hiding additional information and graphs, etc.), changing NPC 530 behaviour (disclosing or obfuscating information) or even changing the storyline, by adding/removing new incidents/tasks to the main story or adding multiple endings. The system 100 therefore is able to provide fully dynamic storytelling for a given user, allowing active learning for each of a series of training sessions.

Here, a plurality of user devices 105 are used to collect user biometric data 110 prior to the user first interacting with the training environment 500.

User biometric data 110 may be collected from devices such as user wearable devices, so that the data can be used in the personality biometric profile 120 for the user that allows for preliminary user personality traits (or personality characteristics) 140 for that user to be determined.

A machine learning algorithm 150 may be used to generate the personality biometric profile 120 for the user. Here, the machine learning algorithm 150 may assess the user biometric data 110 and associate different aspects of the data with certain personality traits 140, which may be stored in or with the personality biometric profile 120.

The types of personality traits associated with a user may include (but are not limited to):
Stressed
Assertive
Leadership
Conscientiousness
Openness
Receptive

The machine learning algorithm 150 may employ any suitable machine learning technique in generating the personality biometric profile 120 for the user. For instance, the machine learning algorithm 150 may comprise Artificial Neural Network (ANN) techniques such as Long Short-Term Memory (LSTM) for sequences of data (for instance, movement data) and/or Convolutional Neural Networks (CNN). The machine learning technique chosen may depend upon the type of biometric data 110 being collected.

In some embodiments, the machine learning algorithm 150 may initially generate the personality biometric profile 120 for the user based only upon the biometric data 110 collected for that user. Alternatively, the machine learning algorithm 150 may be trained on an initial general dataset for a plurality of different users, such that the machine learning algorithm 150 is able to form initial general associations between certain biometric data and particular personality traits. These general associations can then be optimised over time for the specific user in question as more user biometric data 110 is collected for that specific user.

Once an initial personality biometric profile 120 is generated for the user, the profile may be stored by the system 100 in a suitable storage medium, such as a database or memory 200. The stored personality biometric profile 120 may then be periodically updated as further user biometric data 110 is collected and the machine learning algorithm 150 perfects the personality biometric profile 120 for that user. In those embodiments where the personality traits 140 do not form part of the user biometric profile 120, the personality traits 140 may be stored in the memory 200 along with the user biometric profile 120.

As the machine learning algorithm 150 updates the personality biometric profile 120 (and corresponding personality traits 140), the machine learning algorithm 150 may be retrained to that specific user, such that each iterative update more accurately reflects the user in question.

Previous versions of the personality biometric profile 120 (and, where appropriate, the personality traits 140) may be retained in the memory 200 as more recent versions are stored, thereby allowing for the changes in user behaviour or personality traits over time to be assessed as the user undergoes successive training sessions.

The initial personality biometric profile 120 for the user is used by the training environment 500 to generate an initial training session. Using the initial personality biometric profile 120 and the personality traits 140 for that user, the initial training session in the training environment 500 can be tailored for that specific user, even though that user has not yet interacted with the training environment 500.

The user is then able to take part in the initial training session in the training environment 500, where the training scenario is already personalised for the user question, rather than requiring a set of general default parameters to be applied to the initial training scenario. As a result, the user's learning experience is enhanced even from the first training session.

The training environment 500 may be controlled by a machine learning algorithm, or an “AI agent” 510. The AI agent 510 may be configured to control the training environment 500 and dynamically adapt the training scenario during each training session.

The user may interact with the training environment 500 through a laptop or desktop computer, or may interact with the training environment 500 using virtual reality (VR). Such a VR environment 520 may, for example, be implemented through augmented reality (AR), mixed reality (MR), full virtual reality (VR), or any other appropriate extended reality (XR) system.

The type of machine learning algorithm for the AI agent 510 may be chosen based upon the manner in which the user interacts with the training environment 500. For instance, if the user interacts with the training environment 500 via a VR environment 520 (i.e. through a VR headset), then the most appropriate type of machine learning algorithm may be chosen for the AI agent 510 in order to best control such the VR environment 520.

During the training session, user biometric data 110 may be collected continuously, allowing for the personality biometric profile 120 to be periodically or continuously updated during the session. As a result, the training scenario may be updated or adapted in real-time in response to current changes in the user's biometric data 110. The updating or adapting of the training scenario may be carried out by the AI agent 510.

The AI agent 510 may control the behaviour of non-player characters (NPCs) 530 in the training environment 500. NPCs 530 may provide the user with information relevant to the training scenario during the training session, or may act upon decisions made by the user during the training session.

In some embodiments, one or more of the NPCs 530 may be another user (such as a human trainer), who may act on prompts from the AI agent 510 (for instance, to provide the user being trained with more information), or act independently of the AI agent 510 (for instance, making their own decisions about how best to interact with the user being trained).

User behaviour data 300, corresponding to the user's behaviour during the training session, is also recorded throughout the training session. User behavioural data 300 relates to the physical actions or choices a user makes during the training session. For example, user behavioural data 300 may include, but is not limited to:
The time taken by the user to select an option in the training environment.
How often the user selects the correct option in the training environment.
How quickly the user selects the correct option in the training environment.
How many conversations the user has with NPCs 530 in the training environment.
Whether the user was able to solve a problem without hints or any interaction with any NPCs 530.
How often the user makes an apparently random selection in the training environment.

The AI agent 510 may dynamically update, modify, or adapt the training environment 500 in response to observed user behaviour (i.e. user behavioural data 300). For instance, if the user is experiencing difficulty in solving a particular problem, the AI agent 510 may provide a “hint” towards the solution, such as by highlighting a particular item in the environment (which, in some scenarios, may be the VR environment 520) or by providing further information to the user.

The AI agent 510 may also dynamically adapt the training scenario in real-time based on user behaviour (i.e. user behavioural data 300), such as by changing the difficulty of upcoming problems in the training scenario to be easier or harder based on the user's behaviour with regard to solving the current problem in the training scenario. Similarly, the AI agent 510 may dynamically adapt or change the storyline of the training scenario based on the user's behaviour during the training session.

The AI agent 510 may also initially hide or lock certain options in the environment during a training session, only providing access to those options if the user's behaviour indicates that they would benefit from such access. For instance, if the user is struggling to solve a particular problem, the AI agent 510 may make an initially locked or unavailable option accessible, thereby adapting the training scenario to account for the user's difficulty.

The AI agent 510 may dynamically adapt the training environment and/or the training scenario according to a pre-set series of modification options that are available for that environment or scenario.

After the training session, the user behaviour data 300 is then used to update the personality biometric profile 120. This then allows for the further optimisation of the personality biometric profile 120 for that user for the next training session.

This additionally allows for the personality biometric profile 120 to be updated based on the learning experience of the user in the training session. As the user learns during the training session, the associated user behaviour data 300 may reflect the user's learning from that session. For instance, the user may adapt during the training session to the level of stress elicited by the training scenario, resulting in a change in their behaviour (for example, they may progressively solve problems faster as the session progresses). This may be reflected in the user behaviour data 300, which is then used by the machine learning algorithm 150 to update the user's personality biometric profile 120.

The updated personality biometric profile 120 for that user is then used to generate the next training scenario in the training environment 500.

As a result, as the user takes part in a series of training sessions, the system 100 iteratively updates the personality biometric profile 120 for that user, generating each training scenario such that it is optimised and appropriate for that user's personality traits 140 and their current training progress.

FIG. 2 shows the process by which the personality biometric profile 120 is generated, and how the use of third-party devices and wearables may be used to carry out the pre-collection of biometric data. It will be understood that not all the elements shown in the figure may necessarily be implemented in all embodiments, and that the system may be implemented with fewer, or more, elements than those shown.

This allows for the building of a user biometric profile 120 for that specific user, so that that profile can be used to right away create a unique and tailored session for the user, removing the need of using default values and settings and removing the unnecessary initial time to learn/collect user behaviour during a training session.

After a training session starts, the system 100 may still collect user biometric data 110 in order to further improve the personality biometric profile 120 and dynamically change the training environment.

Prior to the user's first training session, each of the plurality of user devices 105 collects user biometric data 110. In some embodiments, the user biometric data 110 may be collected over a period of time by an application on one of the user's device (e.g. on a mobile phone), before being provided to the machine learning algorithm 150 of the system 100.

In some embodiments, each device of the plurality of user devices 105 may be configured to collect and store the user biometric data 110, so that the user biometric data 110 can be transferred to the machine learning algorithm 150 of the system 100 at a later time. Alternatively, in some embodiments, the plurality of user devices 105 may be configured to automatically upload the user biometric data 110 (e.g. via the application) either periodically or continuously. This may be achieved via a wireless connection (i.e. if the device in question communicates with the rest of the system 100 via the application and over a Wi-fi or Bluetooth connection).

The user biometric data 110 may be uploaded and processed in the cloud such that when the user does interact with the training environment 500, the system 100 can obtain the personality biometric profile 120 and personality trait data 140. This enables the training environment 500 to provide a tailored experience right from the first point of use, making the user experience more personalised and removing the processing constraints when starting a training session (allowing more processing to be directed to the experience rather than initial training).

In some embodiments, one or more of the plurality of user devices 105 may collect data on a user's gait, where the device may be a device with an accelerometer (such as smartwatches, mobile devices, or other IoT devices).

In some embodiments, one or more of the plurality of user devices 105 may collect data on a user's general movement. Here, the device may be a device with, for example, one or more of an accelerometer, a gyroscope, GPS capabilities, or other suitable location and movement sensing system (such as a smartwatch or mobile phone).

In some embodiments, one or more of the plurality of user devices 105 may collect data on a user's heart rate, where the device may for instance be a smartwatch or fitness tracker, or any other suitable wearable device. Here, the user's heart rate may be gauged so that ranges and averages of user heart rate over a given time period can be calculated during different activities.

In some embodiments, one or more of the plurality of user devices 105 may collect data on a user's eye movements or eye saccades (i.e. the “darting” movement that eyes make). This data may be collected when the user is carrying out a specific task, or may be collected over a period of time. A user's eye movements or eye saccades can be detected with general or infrared cameras, for example a webcam or a camera within a VR headset.

The user biometric data 110 collected from the plurality of devices 105 can then be compiled to generate the personality biometric profile 120.

As discussed above, the personality biometric profile 120 is a profile that may be initially comprised of biometric data 110 and personality traits 140 for a user (i.e. derived from biometric information collected from the plurality of devices 105, such as user wearable devices). As the user is trained over one or more training sessions, the personality biometric profile 120 is further augmented with user behavioural data 300 that optimises the personality biometric profile 120 for that user's particular personality traits 140.

In some embodiments, user behavioural data 300 may also be collected prior to the user being trained in their first training session. For instance, initial behavioural data for that user may be collected in an analogous manner to the initial collection of the user biometric data 110, such as by sensors in the user's local environment, or may be collected from an external source (e.g. from a questionnaire or other behavioural assessment).

In such a case, the generated personality biometric profile 120 may be initially comprised of both physiological (i.e. biometric) and behavioural traits for the user (i.e. derived from both collected biometric information and behavioural information).

The personality biometric profile 120 for each user is generated through a continual collection of biometric data 110 from a user. The biometric data 110 may have been specifically collected from the user while they have been in scenarios that elicit certain personality traits. For example, a user may experience a scenario that elicits “stress” or “happiness”, and the collected user biometric data 110 may reflect this. In such a scenario, the user biometric data 110 may be collected by any one or more of a variety of suitable sensors (such as, for example, accelerometers, cameras for measuring facial expressions, microphone sensors, or heart rate monitors).

The data collected from the one or more sensors may be compared with the data from other sensors to establish whether the user is experiencing a certain elicited personality traits. For instance, if a sensor measuring movement collects significant movement data while a heart rate monitor detects a high heart rate, it may be concluded that the user is possibly not simply nervous. Alternatively, if no movement is detected by a movement sensor, but a microphone sensor records audio of a conversation and the heart rate monitor detects a high heart rate, then it may be concluded that the user is nervous due to the conversation. This may then be included in the personality biometric profile 120 for that user.

In some embodiments, the personality biometric profiles 120 of a number of users may be used to develop one or more “template” personality biometric profiles. Such template profiles then represent a general biometric personality profile that can be personalised to a new user using that user's specific user biometric data 110. Where multiple “template” personality biometric profiles are used, each template profile may relate to a different average user personality type.

The use of such “template” personality biometric profiles may be useful if an insufficient number of observable personality traits are initially collected for a given user (for instance, due to lack of biometrics). Here, the system may default to the “template” personality profiles, which are each generic. However, as more user biometric data 110 is collected for that user this would then be used to identify the particular personality type of that user. This (now user-specific) user biometric data 110 may then be compared to “template” personality biometric profiles for different personality types (e.g. by the machine learning algorithm 150) to decide on the specific user's personality type.

The machine learning algorithm 150 is used to generate the personality biometric profile 120 for each user. In this regard, machine learning techniques such as “Long Short-Term Memory” may be employed that allow for an Artificial Neural Network (ANN) to be constructed for each modality of the biometric personality template (e.g. gait) that can aid in comparison of future samples.

It will be understood that different biometric data may require different types of machine learning classifier, and that an appropriate classifier may be selected based on the type of use biometric data 110 in question (e.g. heart rate, gait, posture).

In some embodiments, the user biometric data 110 and the user behavioural data 300 may be used by the machine learning algorithm 150 using a federated learning implementation, through an iterative process broken up into a set of client-server interactions known as a federated learning round.

Federated (or collaborative) Learning is a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed. Federated learning enables multiple actors (or elements) to build a common, robust machine learning model without sharing data, thus allowing to address critical issues such as data privacy, data security, data access rights and access to heterogeneous data.

Each round of this federated process consists in transmitting the current global model state to participating nodes, training local models on these local nodes to produce a set of potential model updates at each node, and then aggregating and processing these local updates into a single global update and applying it to the global model.

For example, assuming a federated round composed by one iteration of the learning process, the learning procedure may be summarised as follows:

Initialization: according to the server inputs, a machine learning model (e.g. linear regression, neural network, boosting) is chosen to be trained on local nodes and initialized. Then, nodes are activated and wait for the central server to give the calculation tasks.

Client selection: a fraction of local nodes is selected to start training on local data. The selected nodes acquire the current statistical model while the others wait for the next federated round.

Configuration: the central server orders selected nodes to undergo training of the model on their local data in a pre-specified fashion (e.g. for some mini-batch updates of gradient descent).

Reporting: each selected node sends its local model to the server for aggregation. The central server aggregates the received models and sends back the model updates to the nodes. It also handles failures for disconnected nodes or lost model updates. The next federated round is started returning to the client selection phase.

Termination: once a pre-defined termination criterion is met (e.g., a maximum number of iterations is reached, or the model accuracy is greater than a threshold) the central server aggregates the updates and finalizes the global model.

In some embodiments, user data input into the machine learning algorithm 150 may produce a score as to which personality traits 140 the user biometric data 110 or user behaviour data 300 matches. For example, a high amount of gait movement from a user may indicate that the user is nervous as their movement is greater than expected.

To determine scores for a user's personality biometric profile 120, a sample of biometric or behavioural data from the user is required (e.g. accelerometer data over a period of time). This sample may be biometric data 110 collected from the plurality of devices 105 for the user, and may also include behavioural data 300 collected during a previous training session. The data sample from the user is then classified through the machine learning algorithm 150 to the existing personality biometric profile 120. A score can then be obtained that reflects the closeness of the match of the user's biometric modality to a known personality trait. Here, assessment of the match may be learned over time for that particular user, or may be (at least initially) based upon known matches from a generic database of personality traits and modalities for a sample of multiple users.

Due to the collection of multiple modalities (e.g. gait and eye saccades) a fused score may be produced by combining the scores from each modality. Because different biometrics may result in more accurate matches that others (e.g. gait may prove to be a weak indicator of personality) the scores from each modality may be weighted and then fused, as below:

$$\frac{( {weight}_{1} \times {score}_{1} ) + ( {weight}_{2} \times {score}_{2} ) + … + {( weight}_{n} \times {score}_{n} )}{n}$$

This results in a single score for each personality trait (e.g. Stress—70%, Calmness—30%). Such scores for each personality trait can then be utilised to influence and adapt the user's behaviour during a training session in a direction that the system 100 desires.

This process of scoring for different personality traits may occur continuously such that samples of biometric 110 or behavioural 300 data are sampled regularly.

Scoring may be carried out based on each of the user biometric data 110 (and, optionally, user behavioural data 300), and those scores may be used to score individual personality traits or combinations of them.

Some personality traits, and the associated scores for those traits, may only be determined based on data from a training session. For instance, where a personality trait can only be determined from data that can only be collected during a training session (e.g. traits that can be derived only from data collected during a training session). In such a case, the initial training scenario may be generated based on those personality traits that can be determined from the initially collected user biometric data 110, and further personality traits (and corresponding scores) may be added only after the user has taken part in one or more training sessions.

The machine learning algorithm 150 is therefore able to generate the personality biometric profile 120 and associated personality traits 140 based on user biometrics data 110 (and, in some embodiments, user behavioural data 300). The result is a list of personality traits 140 for that user (in some embodiments, with different scorings) that can be used to understand the current personality state of the user.

As the user undergoes sequential training sessions, the personality biometric profile 120 is iteratively updated based on collected user biometric data 110 and user behavioural data 300. The user biometric data 110 and user behavioural data 300 may be collected during each training session, allowing for the personality biometric profile 120 to be updated in real-time, or subsequent to each training session. As a result, the training sessions can be continually updated based on the user's scored personality traits, thereby providing a continuing tailored training experience for the user.

FIG. 3 shows the process by which the training environment 500 is dynamically adapted (for instance, by the AI agent 510) during a training session, and the collection of behavioural data 300 from the user during a training session. Again, it will be understood that not all the elements shown in the figure may necessarily be implemented in all embodiments, and that the system may be implemented with fewer, or more, elements than those shown.

The information gathered about the user's actions or behaviour during the training session can determine how the storyline for the training scenario is modified. The modifications may be made to create a non-linear story, and/or to adjust the story complexity depending on one or both of two factors: current user behaviour and/or objectives for the session (e.g. training). This provides flexibility and adaptability in the training for each user, depending on the user's personality, behaviour, and training needs.

For example, a user with more experience may struggle as much as a user with less experience working on a similar story or scenario, but the necessary adaptations to the story or scenario may vary for each user. This also enables the system 100 to assess the user's adaptability to non-linear or changing conditions, a trait that is valued in many industries.

The training environment 500 may use computer-controlled players, or NPCs 530, in the training scenario, and make modifications to the training scenario during a training session in order to apply natural, smooth, or non-absurd changes to the storyline of the scenario. For example, NPCs 530 could be modified during a training session to be more cooperative or less cooperative, new or different story paths may be added to enable the user to reach the end goal, new conditions may be introduced that were previously included in past scenarios or training sessions, or the storyline could be changed to suit (or not suit) the user's personality traits 140.

As an example, the user may be struggling to fully understand the next step in the training scenario. They may react by going around multiple graph tools and taking an excessive amount of time to make a specific decision. The AI agent 510 may therefore feed more relevant information to the NPCs 530 and encourage the user to communicate with the NPCs 530 to obtain that additional relevant information.

In addition, modifications can be made during a training session through manipulation of the environment or dropping hints for the user. Where the user interacts with the training environment 500 through a VR environment 520, such modifications may be made to the VR environment 520 during the training session. Where the user interacts with the training environment 500 through a conventional computer display (e.g. desktop, laptop, or tablet computer), such modifications may be made to the environment displayed on that computer. For instance, hints can be dropped in forms of visual information such as graphs, 3D Objects (e.g. tools), or visual cues including sounds and highlighting areas/objects.

The user behavioural data 300 (and, in some embodiments, the user biometric data 110) that is collected during a training session may be different depending on the medium by which the user interacts with the training environment 500. That is so say, if the user interacts with the training environment 500 through a desktop computer, the behavioural data 300 (and/or user biometric data 110) collected may be different to a case where the user interacts with the training environment 500 through a VR environment 520 using a VR headset. For instance, in a VR environment 520, the user's body language or hand signals may be collected as they move around the environment, whereas it may not be possible to collect this type of data if the user is sat down before a desktop computer.

If the user biometric data 110 collected during a training session indicates that the user is experiencing excessive levels of stress, then the training scenario may be adapted by the AI agent 510 with the intention of reducing the user's stress levels to an acceptable level.

Additional user biometric data 110 on a user's eye movements may be collected during a training session. For instance, where the user interacts with the training environment 500 through a desktop or laptop computer, a camera sensor may track user eye movement or eye saccades. Where the user interacts with the training environment 500 through a VR environment 520, sensors in the user's VR headset may track eye movement, such as eye saccades, using a camera (e.g. visible and/or infrared camera(s)) located within the headset. This user biometric data may allow for the system 100 (or specifically the AI agent 510) to conclude that the user is, for example, experiencing uncertainty, confusion, or excessive indecision. The scenario may then be adapted accordingly in response to address the user's inferred current state.

In some embodiments, the changes in the storyline of the scenario may adjust the importance of assessment metrics for that scenario. For instance, if a user is placed in time sensitive situation it could be more important for them to make a quick decision rather than communicate with every NPC 530 in the scenario.

Changes or modifications to the training scenario during a training session may be applied only after a threshold is met. For instance, modifications may only be made after a certain number of user decisions are made, or only after a given time interval. This parameter can be predefined by a system administrator, or could be automatically adapted by the AI agent 510. This then enforces active learning for the user throughout the training session.

In some embodiments, the system 100 reacts not only to collected biometric 110 and behavioural 300 data for the user, but also learns personalised biometric thresholds for the user, so that the training session can be further personalised to the individual user.

This may be achieved by measuring an estimation of a user's biometrics in certain conditions. For example, one user might have a heart rate of 130 when a stressful situation occurs, and another user might have a heart rate of 150. These thresholds may be learned (e.g. through running the user through some emotion-eliciting experiences during initial set-up) so that specific thresholds can be set for each user. It will be understood that this is not limited to heart rate and could be applied using other collected biometrics or behaviours, such as movement (i.e. some users may be more active than others during certain emotional states).

This allows for the training sessions to be more fine-tuned for the user, and for the system 100 to accurately detect whether a user feels a particular way or whether the current biometrics are just their “normal” biometrics.

The inclusion of personalised biometric thresholds allows for the presentation of a more accurate story or training scenario, and therefore fewer cases of misidentified user emotions.

After a training session, user biometric data 110 may still be collected between training sessions to update the user biometric profile 120, but this may be done with a less frequency compared with the initial collection of such data for the generation of the user biometric profile 120.

User behavioural data 300 (or user biometric data 110 from the plurality of devices 105) collected during previous training sessions may be used to update or influence the training scenario for the next training session for that user. This may involve the sampling of user behavioural data 300 (or user biometric data 110 from one or more of the plurality of devices 105) during a training session such that when the training session ends the data can be combined with existing personality biometric profile data to retrain the machine learning algorithm 150 for that specific user.

For example, if a personality biometric profile 120 consisting of a Support Vector Machine (SVM) was created based on user biometric data 110, and then new behavioural or biometric data was collected during a training session, then after the training session the new data could be combined with the existing user data and used to retrain/refine the SVM.

This ensures the personality biometric profile 120 is consistently iterated or changed over time based on newly collected biometric 110 and/or behavioural 300 data of the user.

In addition, newly collected biometric 110 and/or behavioural 300 data may be weighted when updating the personality biometric profile 120 by the machine learning algorithm 150, thereby adding greater relevance to more recent biometric 110 and/or behavioural 300 data. This serves to further improve the accuracy of the personality biometric profile 120, and the associated personality traits 140 for that user, compared with the user's “true” (or actual) current personality traits.

FIG. 4 shows a flowchart of the process 1000 for training a user on the system 100 according to one or more embodiments. Once again, it will be understood that not all the elements shown in the figure may necessarily be implemented in all embodiments, and that the system may be implemented with fewer, or more, elements than those shown.

At step 1100, the user allows biometric data 110 to be collected from a plurality of devices 105 (e.g. wearable devices such as a smartphone, smartwatch, or other IoT device). The biometric data 110 may be collected through an application, for instance on the user's smartphone.

Optionally, user biometric data 110 and user behavioural data 300 may also be collected from sensors in the user's local environment. For example, such data may include, but is not limited to, the user's general movement in their local environment, their eye saccades while observing a display (i.e. a computer display or a VR headset), or their decision making speed when carrying out certain task(s). As a further example, cameras in the user's local environment may track body movements that could relate to a personality type, where for instance slouching might be interpreted as “low confidence” whereas bold posture might be interpreted as “high/higher confidence”.

At step 1200, the system 100 generates a personality biometric profile 120 for the user based on the user biometric data 110 (and, optionally, user behavioural data 300). A machine learning algorithm 150 may be employed to assess and classify the user biometric data 110 (and, optionally, user behavioural data 300) in order to generate a list of personality traits 140 that are tailored for that user.

The machine learning algorithm 150 may assign weights to different modalities of the user biometric data 110 of the user biometric profile 120, and assign scores for different personality traits 140 for that user.

The user biometric profile 120 and personality traits 140 may be stored in a memory 200. As the user biometric profile 120 and personality traits 140 are updated over time, subsequent updated user biometric profile 120 and personality traits 140 may be stored in the memory 200, forming a record of changes in the personality traits 140 of the user over time.

At step 1300, the system 100 uses the user biometric profile 120 and the user personality traits 140 to generate a tailored training scenario in a training environment 500 for the user. For instance, the level of difficulty of the generated training scenario may be automatically determined using the user biometric profile 120 and personality traits 140 for that user such that it is most appropriate for that user. This removes the need for multiple trainers or role-players (i.e. other users providing training) at the training session, thereby avoiding any unnecessary downtime from everyday duties for those multiple trainers.

Where the personality traits 140 for the user have previously been scored by the machine learning algorithm 150, the scores may be used to further improve the tailoring of the training session to the user in question.

The tailored training scenario generated for the user may include a storyline based on real past events, with problems and objectives to be solved by the user in a training session.

At step 1400, the user takes part in the training session, experiencing the tailored training scenario in the training environment 500. Here, the user may interact with one or more NPCs 530 to solve problems and resolve issues as part of the tailored training scenario. The training environment 500 may be controlled by an AI agent 510.

The user may interact with the training environment 500 during the training session through a conventional desktop computer, laptop, or tablet, or may interact with the training environment 500 during the training session through a VR environment 520.

At step 1500, the training environment 500 collects user behavioural data 300 during the training session, for example the time taken for the user to select an option or make a decision, or the number of conversations a user has with NPCs 530.

The collected user behavioural data 300 may be passed to the machine learning algorithm 150 to update the user biometric profile 120 and the associated personality traits 140 based on the user behavioural data 300. The user biometric profile 120 and the associated personality traits 140 may be updated after the training session, or may be updated during the training session in real-time.

Where the user biometric profile 120 and the associated personality traits 140 are updated during the training session in real-time, the training environment 500 may respond by updating the training scenario in real time. This dynamic adaptation of the training scenario during the training session allows for the training session to be further tailored or fine-tuned to the particular user in question.

Where the training environment 500 is controlled by an AI agent 510, the AI agent 510 may, at step 1600, analyse collected user behavioural data 300 and directly modify the training environment 500 in response to the user's behaviour.

Here, the AI agent 510 may modify the storyline as well as the environment (which may be the VR environment 520) to force the user to learn and change behaviour in order to optimize the personality attributes. The AI agent 510 may make such modifications after evaluating the user personality profile 120 and user personality traits 140 updated in real time, or may act directly in response to observed user behaviours (i.e. collected user behavioural data 300) in real time.

At step 1700, after the training session, the system 100 passes collected user behavioural data 300 (and, optionally, user biometric data 110) to the machine learning algorithm 150 to make any further updates to the user biometric profile 120 and associated personality traits 140 for the user (for instance, where the user biometric profile 120 and associated personality traits 140 were not updated during the training session).

The system 100 may also produce a report showing where and when the user showed higher or lower performance, based on training goals or appropriate thresholds (for example, the time taken to solve a problem, or the amount of information needed to find the solution to a problem). The report may be used by the training environment 500 in generating the training scenario for the next training session (i.e. by providing an understanding of specific training aspects where the user requires additional training). The report may also be provided to a system administrator or human trainer for review.

At step 1800, the system 100 returns to step 1300, and generates a second training scenario tailored for the user, based on the updated user biometric profile 120 and associated personality traits 140.

The second training scenario generated for the user may include a new storyline based on different real past events to that of the first training scenario, and may comprise new problems and objectives to be solved by the user in the second training session.

The user may then take part in the second training session, experiencing the tailored second training scenario in the training environment 500.

The second training session may be run and controlled in the same manner as the initial training session discussed above in steps 1400 to 1700. That is to say, the training environment may collect user behavioural data 300 (and, optionally, user biometric data 110) throughout the second training session, and the training scenario and environment (which may be a VR environment 520) may be dynamically adapted in real time throughout the second training session.

In this manner, the user biometric profile 120 and personality traits 140 are iteratively updated for the user in question, so that each successive training session (i.e. the third, fourth, fifth training sessions and so on) is tailored for the user, thereby better enabling and encouraging of their learning.

The above discussed method may be performed using a computer system or similar computational resource, or system comprising one or more processors and a non-transitory memory storing one or more programs configured to execute the method. Likewise, a non-transitory computer readable storage medium may store one or more programs that comprise instructions that, when executed, carry out the method of adaptive learning for the user.

Whilst certain embodiments have been described, these embodiments have been presented by way of example only, and are not intended to limit the scope of the application. Indeed, the novel devices, and methods described herein may be embodied in a variety of other forms; furthermore, various omissions, substitutions and changes in the form of the devices, methods and products described herein may be made without departing from the scope of the present application. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage. The accompanying claims and their equivalents are intended to cover such forms or modifications as would fall within the scope of the application.

1. A method of providing adaptive training to a user in a training environment, the method comprising:
receiving a personality biometric profile and one or more personality characteristics of a user;
generating, by a machine learning agent, a training scenario for the user, wherein the training scenario is generated based on the personality biometric profile and the one or more personality characteristics of the user;
training the user in a training session using the training scenario;
wherein, during the training session, the machine learning agent modifies the training scenario in real time based on user behavioural data that reflects the user's behaviour in the training session.

2. The method of providing adaptive training to a user according to claim 1, wherein the machine learning agent controls a plurality of non-player characters in the training scenario, and wherein modifying the training scenario includes modifying the behaviour of one or more of the plurality of non-player characters.

3. The method of providing adaptive training to a user according to claim 1, wherein modifying the training scenario is based on user behavioural data exceeding a threshold.

4. The method of providing adaptive training to a user according to claim 1, wherein the training scenario is modified based on an assessment, by the machine learning agent, of the current personality state of the user, wherein the assessment is based on the user behavioural data.

5. The method of providing adaptive training to a user according to claim 1, wherein generating the training scenario for the user is based on a weighted score for each personality characteristic of the user.

6. The method of providing adaptive training to a user according to claim 1, wherein the training scenario is modified in order to achieve a training goal.

7. The method of providing adaptive training to a user according to claim 1, wherein training the user in the training session comprises the user being trained in a VR environment, and wherein modifying the training scenario includes modifying the VR environment.

8. The method of providing adaptive training to a user according to claim 1, wherein the training scenario is modified according to a pre-set series of modification options.

9. The method of providing adaptive training to a user according to claim 1, wherein the training scenario comprises a plurality of tasks to be completed by the user in the training session, and wherein modifying the training scenario based on the user's behaviour includes one or more of:
including one or more additional tasks or removing one or more existing tasks;
changing the difficulty of one or more tasks;
changing the complexity of one or more tasks;
providing a hint to the user related to the current task; or
including or removing additional information provided to the user related to the current task.

10. The method of providing adaptive training to a user according to claim 2, wherein the training scenario comprises a plurality of tasks to be completed by the user in the training session, and wherein the user behavioural data includes one or more of:
the time taken by the user to select an option during a task;
how often the user selects the correct option when completing one or more of the plurality of tasks;
how quickly the user selects the correct option during one or more task;
how many interactions the user has with the plurality of non-player characters in the training scenario, or
how often the user makes a random selection during one or more tasks.

11. The method of providing adaptive training to a user according to claim 1, wherein the user biometric profile is updated based on the user behavioural data, and a next training scenario for the user is generated by the machine learning agent subsequent to the training session based on the updated user biometric profile.

12. The method of providing adaptive training to a user according to claim 1, wherein the personality biometric profile is updated subsequent to the training session based on user biometric data collected from a plurality of user devices during the training session.

13. The method of providing adaptive training to a user according to claim 1, wherein the one or more personality characteristics comprises one or more of Stressed, Assertive, Leadership, Conscientiousness, Openness, and Receptive.

14. A system comprising:
one or more processors;
a non-transitory memory; and
one or more programs, wherein the one or more programs are stored in the non-transitory memory and configured to be executed by the one or more processors, the one or more programs including instructions for performing the method of claim 1.

15. A non-transitory computer readable storage medium storing one or more programs, the one or more programs comprising instructions, which, when executed by an electronic device with one or more processors, cause the electronic device to perform the method of claim 1.
